(19) United States
(12) Patent Application Publication
(10) Pub. No.: US 2017/0287515 A1
(43) Pub. Date: Oct. 5, 2017

(54) HEXAGONAL FERRITE POWDER, MAGNETIC RECORDING MEDIUM, AND METHOD OF HEXAGONAL FERRITE POWDER

(71) Applicant: FUJIFILM Corporation, Tokyo (JP)

(72) Inventor: Masashi SHIRATA, Minami-ashigara-shi (JP)

(73) Assignee: FUJIFILM Corporation, Tokyo (JP)

(21) Appl. No.: 15/474,418

(22) Filed: Mar. 30, 2017

(30) Foreign Application Priority Data
Mar. 31, 2016 (JP) 2016-073493

(51) Int. Cl. G11B 5/65

(52) U.S. Cl. CPC G11B 5/653

(57) ABSTRACT

The hexagonal ferrite powder has an activation volume of greater than or equal to 800 nm³ but less than 1,200 nm³, a rare earth atom content falling within a range of 0.5 to 8.0 atom % per 100 atom % of iron atoms, and a localized presence of rare earth atoms in the surface layer portion, as well as is in the form of ellipsoidal powder.

### CROSS-REFERENCE TO RELATED APPLICATIONS

This application claims priority under 35 U.S.C. 119 to Japanese Patent Application No. 2016-073493 filed on Mar. 31, 2016. The above application is hereby expressly incorporated by reference, in its entirety.

### BACKGROUND OF THE INVENTION

### Field of the Invention

The present invention relates to hexagonal ferrite powder, a magnetic recording medium, and a method of hexagonal ferrite powder.

### Discussion of the Background

Hexagonal ferrite powder is widely employed as the ferromagnetic powder contained in the magnetic layer of magnetic recording media. Hexagonal ferrite powder has a coercive force of such a degree that it is also used in permanently magnetic materials. The magnetic anisotropy that is the basis of this coercive force derives from the crystalline structure and thus can be maintained even when the particles are rendered quite small. Further, a magnetic recording medium having a magnetic layer containing hexagonal ferrite powder can exhibit good high-density characteristics due to its vertical component. Thus, hexagonal ferrite powder is ferromagnetic powder that is suited to achieving higher density recording.

In recent years, various proposals have been made about how to further enhance hexagonal ferrite powder having the good characteristics set forth above (for example, see Japanese Unexamined Patent Publication (KOKAI) No. 2015-91747 or English language family members US2015/093600A1, U.S. Pat. No. 9,502,066 and US2017/040032A1 and Japanese Unexamined Patent Publication (KOKAI) No. 2011-178654, which are expressly incorporated herein by reference in their entirety).

### SUMMARY OF THE INVENTION

An example of the performance demanded of a magnetic recording medium is affording good electromagnetic characteristics. One example of a way to enhance the electromagnetic characteristics is reducing the particle size of the ferromagnetic powder.

Magnetic recording media are useful as data storage recording media for the repeated reproduction of recorded signals. To further increase this utility, in addition to exhibiting good electromagnetic characteristics, a low drop in reproduction output with repeated reproduction is desirable. However, the smaller the particles of ferromagnetic powder are made, the more difficult it tends to become to inhibit the drop in reproduction output with repeated reproduction. That is because, the smaller the particle size, the greater the tendency for a phenomenon known as thermal fluctuation to occur.

An aspect of the present raven ion provides for hexagonal ferrite powder permitting the fabrication of a magnetic recording medium that can exhibit good electromagnetic characteristics and a small drop in reproduction output with repeated reproduction.

An aspect of the present invention relates to hexagonal ferrite powder having an activation volume of greater than or equal to 800 nm³ but less than 1,200 nm³;

having a rare earth atom content falling within a range of 0.5 to 8.0 atom % per 100 atom % of iron atoms;

having a localized presence of rare earth atoms in the surface layer portion; and

being in the form of ellipsoidal powder.

That is, extensive research conducted by the present inventor has revealed that a magnetic recording medium having a magnetic layer containing the above hexagonal ferrite powder can exhibit good electromagnetic characteristics and an inhibited drop in reproduction output with repeated reproduction. The present inventor presumes (1) and (2) below in this regard.
(1) The present inventor presumes that having an activation volume falling within the above range can contribute to a magnetic recording medium having a magnetic layer containing the above hexagonal ferrite powder exhibiting good electromagnetic characteristics.
(2) The present inventor presumes that the localized presence of rare earth atoms in the surface layer portion in the above hexagonal ferrite powder and the fact that the powder is ellipsoidal can contribute to reducing the thermal fluctuation of the hexagonal ferrite powder. The localized presence of rare earth atoms in the surface layer portion and the ellipsoidal shape of the powder will be described in detail further below. With regard to the localized presence of rare earth atoms in the surface layer portion, the present inventor presumes that the fact that rare earth atoms are locally present in the surface layer portion of the particles of hexagonal ferrite can contribute to stabilizing the spin of Fe sites within the crystal lattice of the surface layer portion, thereby permitting an improvement in thermal stability. The present inventor presumes that as a result of the decrease in thermal fluctuation, it becomes possible to inhibit a drop in reproduction output with repeated reproduction in the magnetic recording medium having a magnetic layer containing the above hexagonal ferrite powder. The present inventor further presumes that the localized of rare earth atoms in the surface layer portion in the above hexagonal ferrite powder and the ellipsoidal shape of the powder can also contribute to enhancing the electromagnetic characteristics.

However,the above are merely presumptions and do not limit the present invention.

The term “activation volume”, which is the unit of magnetization reversal, is an indicator of the magnetic magnitude of the particles. In the present invention and present specification, the term activation volume and the anisotropy constant Ku, referred to further below, are values that are obtained by measuring at magnetic field sweep rates of 3 minutes and 30 minutes in the coercive force Hc measurement portion with a vibrating sample magnetometer and employing the following expression relating Hc and the activation volume. With regard to the unit of anisotropy constant Ku, 1 crg/cc=7.958×10⁻³ J/m³.

Hc=2Ku/Ms(1−((kt/KuV)ln(At/0.693))^{1/2})

(In the above equation, Ku: anisotropic constant (unit: J/m³), Ms: saturation magnetization (unit: kA/m), k: Boltzmann constant, T: absolute temperature (unit: K), V: activation volume (unit: cm³), A: spin precession frequency (unit: s⁻¹), and t: magnetic field inversion time.)

In the present invention and present specification the “rare earth atoms” are selected from the group consisting of scandium atoms (Sc), yttrium atoms (Y), and lanthanide atoms. The lanthanide atoms are selected from the group consisting of lanthanum atoms (La), cerium atoms (Ce), praseodymium atoms (Pr), neodymium atoms (Nd), promethium atoms (Pm), samarium atoms (Sm), europium atoms (Eu), gadolinium atoms (Gd), terbium atoms (Tb), dysprosium atoms (Dy), holmium atoms (Ho), erbium atoms (Er), thulium atoms (Tm), ytterbium atoms (Yb), and ruthenium atoms (Lu).

In the present invention and present specification, the term “localized presence of rare earth atoms in the surface layer portion” means that the content of rare earth atoms (referred to as the “surface layer portion content” hereinafter) per 100 atom % of the iron atoms in a solution obtained by partially dissolving hexagonal ferrite powder with an acid and the rare earth atom content (referred to as the “bulk content” hereinafter) per 100 atom % of the iron atoms in a solution obtained by fully dissolving the hexagonal ferrite powder with an acid satisfy the ratio:

surface layer portion content/bulk content>1.0

The above “rare earth atom content” of the hexagonal ferrite powder is synonymous with the bulk content. By contrast, the partial dissolution using an acid dissolves the surface layer portion of the hexagonal ferrite powder, and thus the rare earth atom content of the solution obtained by partial dissolution is the rare earth atom content in the surface layer portion of the hexagonal ferrite powder. The fact that the surface layer portion content satisfies the ratio “surface layer portion content/bulk content>1.0” means that rare earth atoms are locally present in the surface layer portion (present in greater quantity than in the interior). In the present invention and present specification, the term “surface layer portion” means a partial region extending from the surface toward the interior.

For hexagonal ferrite powder that is present in the form of powder, the samples of powder for partial dissolution and full dissolution are collected from the same lot of powder. For hexagonal ferrite powder that is contained in the magnetic layer of a magnetic recording medium, a portion of hexagonal ferrite powder that has been removed from the magnetic layer is partially dissolved, and another portion is filly dissolved. The hexagonal ferrite powder can be removed from the magnetic layer by the method described in, for example, Japanese Unexamined Patent Publication (KOKAI) No. 2015-91747, paragraph 0032.

The above-mentioned term “partial dissolution” refers to dissolution to a degree where the presence of residual hexagonal ferrite powder in the solution can be visually confirmed once dissolution has ended. For example, an amount in the vicinity of 10 to 20 weight % of 100 weight % of the powder as a whole can be dissolved in partial dissolution. The above-mentioned term “full dissolution” refers to dissolution to a state where the presence of no residual hexagonal ferrite powder in the solution can be visually confirmed once dissolution has ended.

The partial dissolution and the measurement of the surface layer portion content can be conducted by the following method, for example. The dissolution conditions such as the quantity of sample powder given below are given by way of example; any dissolution conditions can be adopted that permit partial dissolution and full dissolution.

A vessel (such as a beaker) charged, with 12 mg of sample powder and 10 of 1 mol/L hydrochloric acid is maintained for 1 hour on a hot plate at a temperature setting of 70° C. The solution obtained is filtered through a 0.1 μm membrane filter. The filtrate thus obtained is subjected to elemental analysis with an inductively coupled plasma (ICP) analyzer. This makes it possible to determine the surface layer portion content of rare earth atoms per 100 atom % of iron atoms. When multiple types of rare earth atoms are detected by elemental analysis, the combined content of all of the rare earth atoms is adopted as the surface layer portion content. The same applies to measurement of the bulk content.

The above full dissolution and bulk content measurement can be conducted by the following methods, for example.

A vessel (such as a beaker) charged with 12 mg of sample powder and 10 mL of 4 mol/L hydrochloric acid is maintained for 3 hours on a hot plate at a temperature setting of 80° C. Subsequently, the same operations as in the partial dissolution and measurement of the surface layer portion content set forth above are conducted to determine the bulk content per 100 atom % of iron atoms.

In the present invention and present specification, the term “powder” means a collection of multiple particles. For example, the term “hexagonal ferrite powder” means a collection of multiple hexagonal ferrite particles. The term “collection of multiple particles” is not limited to forms where the particles constituting the collection are in direct contact, but also includes forms where the binder and/or additives and the like described further below are present between the particles. The powder or particles of hexagonal ferrite swill sometimes be referred to as “hexagonal ferrite” hereinafter. The term “ellipsoidal powder” refers to powder containing greater than or equal to 50% based or particle number of hexagonal ferrite particles (referred to as “ellipsoidal particles” hereinafter) that are not plate-shaped and satisfy equation (1):

1.2<major axis length/minor axis length<2.0 (1).

The term “plate-shaped” refers to a shape having a main surface. The term “main surface” refers to the outer surface constituting the greatest portion of the surface area of the particle. For example, Table 2 in Japanese Unexamined Patent Publication (KOKAI) No. 2011-178654 gives the plate diameters of particles. The particles for which the plate diameters are specified are, for example, particles of hexagonal planar shape. For example, in a hexagonal planar shape, the surface accounting for the greatest surface area is the outer hexagonal surface. This portion is referred to as the main surface.

The proportion of hexagonal ferrite powder as a whole that is accounted for by ellipsoidal particles is determined for 500 randomly extracted particles. Particles that are not plate-shaped and satisfy equation (1) are calculated as a proportion of all (500) particles. As regards particle size, the longest axis (straight line) running through the particle is adopted as the major axis and the length of the major axis is adopted as the major axis length. The minor axis is determined by taking the longest axis running through particle that is perpendicular to the major axis and adopting the length of this axis as the minor axis length. The shape and size of the particle are measured by observation by transmission electron microscope. Specifically, they are determined for 500 particles in a particle photograph taken by a direct method with a transmission electron microscope (such as a model H-9000 transmission electron microscope made by Hitachi) at an acceleration voltage of 100 kV. More particularly, a particle photograph is taken at 100,000-fold magnification and printed on print paper at a total magnification of 500,000-fold. Target particles are selected on the particle photograph, the contours of the particles are traced with a digitizer, and image analysis software (such as the image analysis software KS-400 put out by Carl Zeiss) is used to observe the shape and measure the size (major axis length and minor axis length) of the particles.

In one embodiment, the above rare earth atoms are one or more types of rare earth atom selected from the group consisting of yttrium atoms, lanthanum atoms, samarium atoms, ytterbium atoms, and neodymium atoms.

In one embodiment, the hexagonal ferrite powder is barium ferrite powder, strontium ferrite powder, or a mixed crystal powder of barium ferrite and strontium ferrite.

In one embodiment, the rare earth atom content (bulk content) falls within a range of 0.5 to 6.0 atom %.

In one embodiment, the rare earth atom content (bulk content) falls within a range of 1.0 to 4.5 atom %.

In one embodiment, the activation volume falls within a range of 850 nm³ to 1,150 nm³.

In one embodiment, the anisotropy constant Ku of the hexagonal ferrite powder is greater than or equal to 1.5×10⁴ J/m³.

A further aspect of the present invention relates to a magnetic recording medium having a magnetic layer containing ferromagnetic powder and binder on a nonmagnetic support, wherein the ferromagnetic powder is the above hexagonal ferrite powder of an aspect of the present invention

A further aspect of the present invention relates to a method of manufacturing the above hexagonal ferrite powder of an aspect of the present invention, including:

mixing an iron salt, divalent metal salt, and rare earth salt in a water-based solution to prepare a hexagonal ferrite precursor; and

continuously feeding the water-based solution containing the hexagonal ferrite precursor to a reaction flow path in which the fluid flowing through the interior thereof is heated and pressurized., thereby converting the hexagonal ferrite precursor to hexagonal ferrite in the reaction flow path.

In one embodiment, the above reaction flow path heats the fluid flowing through the interior to greater than or equal to 300° C. and pressurizes it to greater than or equal to 20 MPa.

In one embodiment, the above mixing is conducted in the presence of a base.

An aspect of the present invention can provide hexagonal ferrite powder permitting the fabrication of a magnetic recording medium exhibiting; good electromagnetic characteristics and undergoing little drop in reproduction output with repeated reproduction, and a magnetic recording medium having a magnetic layer containing this hexagonal ferrite powder as ferromagnetic powder.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the drawing, wherein:

FIG. 1 is a schematic descriptive drawing of an example of a manufacturing device that can be used to manufacture hexagonal ferrite powder employing a continuous hydrothermal synthesis method.

FIG. 2 is a schematic descriptive drawing of an example of a manufacturing device that can be used to manufacture hexagonal ferrite powder employing a continuous hydrothermal synthesis method.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and riot to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Hexagonal Ferrite Powder

An aspect of the present invention relates to hexagonal ferrite powder having an activation volume of greater than or equal to 800 nm³ but less than 1,200 nm³, having a rare earth atom content (hulk content) falling within a range of 0.5 to 8.0 atom % per 100 atom % of iron atoms, having a localized presence of rare earth atoms in the surface layer portion; and being in the thrill of ellipsoidal powder.

The above hexagonal ferrite powder will be described in detail below.

<Activation Volume>

The activation volume of the above hexagonal ferrite powder is greater than or equal to 800 nm³ but less than 1,200 nm³. An activation volume that is less than 1,200 nm³ enables a magnetic recording medium having a magnetic layer containing the above hexagonal ferrite powder to exhibit good electromagnetic characteristics. Further, an activation volume that is greater than or equal to 800 nm³ enables a magnetic recording medium having a magnetic layer containing the above hexagonal ferrite powder to exhibit good electromagnetic characteristics. It also makes it possible to inhibit a drop in reproduction output with repeated reproduction. From the perspectives of further improving the electromagnetic characteristics and further inhibiting a drop in reproduction output with repeated reproduction, the activation volume of the hexagonal ferrite powder desirably falls within a range of 850 nm³ to 1,150 nm³ and preferably falls within a range of 900 nm³ to 1,100 nm³.

<The State in Which Rare Earth Atoms Are Present>

The rare earth atom content (bulk content) of the above hexagonal ferrite powder is 0.5 to 8.0 atom % per 100 atom % of iron atoms. The present inventor presumes that having such a bulk content of rare earth atoms and having a localized presence of rare earth atoms in the surface layer portion can contribute to reducing thermal fluctuation in the hexagonal ferrite powder. Details about the presumptions of the present inventor in this regard are as set forth above. A magnetic recording medium having a magnetic layer containing hexagonal ferrite powder exhibiting good thermal stability with reduced thermal fluctuation makes it possible to inhibit a drop in reproduction output with repeated reproduction. Further, the present inventor presumes that containing the above bulk content of rare earth atoms with a localized presence of the rare earth atoms being present in the surface layer portion can also contribute to enhancing the electromagnetic characteristics. From the perspective of further reducing thermal fluctuation and further enhancing the electromagnetic characteristics, the bulk content desirable falls within a range of 0.5 to 7.0 atom %, preferably falls within a range of 0.5 to 6.0 atom %, more preferably falls within a range of 0.7 to 6.0 atom %, still more preferably falls within a range of 1.0 to 5.0 atom %, yet more preferably falls within a range of 1.0 to 4.5 atom %, yet still more preferably falls within a range of 1.0 to 4.0 atom %, and even more preferably, falls within a range of 1.2 to 4.0 atom %.

The above bulk content is determined by fully dissolving hexagonal ferrite powder. The hexagonal ferrite powder can contain a single type of rare earth atom, or can contain two or more types of rare earth atoms. The bulk content when two or more types of rare earth atoms are contained is determined as the combined total of the two type or more types of rare earth atoms. The same applies to other components in the present invention and present specification. That is, unless specifically stated otherwise, a single type of a given component can be employed, or two or more type can be employed. The content or content ratio when two or more types are employed refers to the combined total of the two or more types.

The rare earth atoms that are contained in the above hexagonal ferrite powder can be any one or more types of rare earth atoms. From the perspective of further improving thermal stability and the electromagnetic characteristics, examples are yttrium atoms, lanthanum atoms, samarium atoms, ytterbium atoms, and neodymium atoms.

The above hexagonal ferrite powder contains one or more rare earth atoms in a bulk content falling within the above range, and the rare earth atoms that are contained are locally present in the surface layer portion. The present inventor presumes that this can contribute to reducing thermal fluctuation of the hexagonal ferrite powder and to enhancing the electromagnetic characteristics of the magnetic recording medium having a magnetic layer containing the hexagonal ferrite powder. Details regarding the presumptions of the present inventor in this regard are as set forth above. It suffices for the rare earth atoms to be locally present in the surface layer portion. The degree to which they are locally present is not limited. For example, as regards the hexagonal ferrite powder, the ratio “surface layer portion content/bulk content” of the surface layer portion content of the rare earth atoms that is determined by partial dissolution under the dissolution conditions given by way of example above to the bulk content of rare earth atoms determined by full dissolution under the dissolution conditions given by way of example above can be greater than 1.0, greater than or equal to 1.5, or greater than or equal to 2.0. The ratio “surface layer portion content/bulk content” of the surface layer portion content of the rare earth atoms that is determined by partial dissolution under the dissolution conditions given by way of example above to the hulk content of rare earth atoms determined by full dissolution under the dissolution conditions given by way of example above can be, for example less than or equal to 10.0, less than or equal to 9.0, less than or equal to 8.0, less than or equal to 7.0, or less than or equal to 6.0. So long is the rare earth atoms are locally present in the surface layer portion as set forth above, the “surface layer portion content/bulk content” is not limited to these upper limits and lower limits given by way of example.

<Shape of the Powder>

The above hexagonal ferrite powder is ellipsoidal powder having an activation volume falling within the above range, having a bulk content of rare earth atoms falling within the above range, and having rare earth atoms locally present in the surface layer portion. The present inventor presumes that being an ellipsoidal powder can also contribute to reducing the thermal fluctuation of the hexagonal ferrite powder. The ellipsoidal powder is as set forth above.

<Atoms Constituting Hexagonal Ferrite>

The atoms constituting hexagonal ferrite include iron atoms and divalent metal atoms. The divalent atoms are ions in the form of metal atoms capable of becoming divalent cations. Examples are alkaline earth metal atoms such as barium atoms, strontium atoms, and calcium atoms, and lead atoms. However, the divalent metal atoms described in the present invention and present specification do not include rare earth atoms. For example, hexagonal ferrite containing barium atoms as divalent metal atoms is barium ferrite. Hexagonal ferrite containing strontium atoms is strontium ferrite. The hexagonal ferrite can he a mixture of the crystals of two or more types of hexagonal ferrite. An example of mixed crystals is mixed crystals of barium ferrite and strontium ferrite.

Known crystal structures of hexagonal ferrite are the magnetoplumbite type (referred to as “M type”), W type, Y type, and Z type. The hexagonal ferrite powder can he of any type of crystal structure. The content of divalent metal atoms of the hexagonal ferrite powder is normally determined by the type of crystal structure of the hexagonal ferrite, and is not specifically limited. The same applies to the iron atom content. The hexagonal ferrite powder contains iron atoms, divalent metal atoms, and rare earth atoms, and can optionally contain additional atoms. From the perspective of further reducing thermal fluctuation, the hexagonal ferrite powder contains iron atoms, divalent atoms, and rare earth atoms, with the content of additional atoms desirably being less than or equal to 5.0 weight %, preferably falling within a range of 0 to 3.0 weight %, and more preferably, 0 weight %, that is, no atoms are contained in addition to iron atoms, divalent metal atoms, and rare earth atoms. The above contents refer to the contents determined by fully dissolving the hexagonal ferrite powder. Accordingly, “not containing” refers to a content of 0 weight % as measured by ICP analyzer with fall dissolution. The detection threshold of an ICP analyzer is normally less than or equal to 0.01 parts per million (ppm) based on weight. The “not contained” referred to above is used with a meaning that includes quantities falling below the detection threshold of an ICP analyzer.

<Anisotropy constant Ku>

Anisotropy constant Ku is an example of an indicator of a reduction in thermal stability, or in other words, enhanced thermal stability The above hexagonal ferrite powder desirably has a Ku of greater than or equal to 1.5×10⁴ J/m³, preferably a Ku of greater than or equal to 1.7×10⁴ J/m³. The Ku of the hexagonal ferrite powder can be, for example., less than or equal to 1.8×10⁴ J/m³. However, the higher Ku becomes, the greater the thermal stability becomes, which is desirable, so there is no limit to these values given by way of example.

Hexagonal ferrite powder according to an aspect of the present invention set forth above can be manufactured by a known method of manufacturing hexagonal ferrite powder, such as the coprecipitation method, reverse micelle method, hydrothermal synthesis method, and glass crystallization method. An example of a desirable manufacturing method is the hydrothermal synthesis method. The hydrothermal synthesis method refers to a method of converting hexagonal ferrite precursor into hexagonal ferrite powder by heating a water-based solution containing hexagonal ferrite precursor. From the perspective of the ease of controlling particle shape and the perspective of the ease of manufacturing hexagonal ferrite powder having rare earth atoms locally present in the surface layer portion, a hydrothermal synthesis method is desirable. Among such methods, from the perspective of the ease of manufacturing, hexagonal ferrite powder according to an aspect of the present invention, the continuous hydrothermal synthesis method of heating and pressurizing a water-based fluid containing hexagonal ferrite precursor while feeding it to a reaction flow path and utilizing the high reactivity of water that has been heated and pressurized, desirably to a subcritical to supercritical state to convert hexagonal ferrite precursor to hexagonal ferrite is desirable. A desirable embodiment of the manufacturing method will be described below in the form of a manufacturing method employing the continuous hydrothermal synthesis method. However, it suffices for the hexagonal ferrite powder according to an aspect of the present invention to be an ellipsoidal powder having an activation volume falling within the range set forth above, having a bulk content of rare earth atoms falling within the range set forth above, and having a localized presence of rare earth atoms in the surface layer portion. It is not limited to hexagonal ferrite powder that is manufactured by the manufacturing method given below

### Method of Manufacturing Hexagonal Ferrite Powder

An aspect of the present invention relates to a method of manufacturing the above hexagonal ferrite powder according to an aspect of the present invention, including:

mixing an iron salt, divalent metal salt, and rare earth salt in a water-based solution to prepare a hexagonal ferrite precursor, and

continuously feeding the water-based solution containing a hexagonal ferrite precursor into a reaction flow path where the fluid flowing through the interior thereof is heated and pressurized to covert the hexagonal ferrite precursor to hexagonal ferrite within the reaction flow path.

The above manufacturing method will he described in greater detail below.

<Preparation of Hexagonal Ferrite Precursor>

(i) Starting materials ori salt, divalent metal salt, and rare earth salt)

It suffices for the hexagonal ferrite precursor (also referred to as the “precursor” hereinafter) to be converted to hexagonal ferrite (to become ferrite) when placed in the presence of heated and pressurized water. Water that has been heated and pressurized will also be referred to as “high-temperature, high-pressure water” hereinafter. The details will be set forth further below. In one embodiment, the precursor can exhibit high solubility in water and dissolve in a water-based solvent, described further below. In another embodiment, the precursor can have poor solubility in water and form colloidal particles that disperse in a water-based solvent (in sol form).

Water-soluble salts of iron, such as halides such as chlorides, bromides, and iodides; nitrates; sulfates; carbonates; organic acid salts; and complexes can be employed as the iron salt. Hydrates can also be employed.

Salts which contain one or more divalent metal atoms described above can be employed as divalent metal salts. The type of divalent metal salt can be determined based on the desired hexagonal ferrite. For example, when barium ferrite is desired, a divalent metal salt in the form of a barium salt is employed. When strontium ferrite is desired, a strontium salt is employed. When mixed crystals of barium ferrite and strontium ferrite are desired, it suffices to employ divalent metal salts in the form of a barium salt and a strontium salt in combination. The salt is desirably a water-soluble salt. For example, hydroxides; halides such as chlorides, bromides, and iodides; and nitrates can be employed. Hydrates can also be employed

The mixing ratio and quantities of the iron salt and divalent metal salt that are added can be determined based on the desired ferrite composition,

The salts of various rare earth atoms set forth above are examples of rare earth salts, Water soluble salts are desirable as rare earth salts. For example, hydroxides; halides such as chlorides, bromides, and iodides; and nitrates can be employed. Hydrates can also be employed.

So long as hexagonal ferrite powder contains rare earth atoms in a bulk content falling within the range set forth above, the quantity of rare earth salt employed is not specifically limited. From the perspective of the ease of manufacturing the above hexagonal ferrite powder, the quantity of rare earth salt employed, as a value calculated from the quantities of rare earth salt and iron salt employed, desirably falls within a range of 0.5 to 8.0, and preferably within a range of 1.0 to 6.0, as the molar ratio of rare earth atoms M to iron atoms (M/Fe). When two or more salts of different types of rare earth atoms are employed as the rare earth salt, M refers to the combined total of the two or more types of rare earth atoms.

The salts set forth above can be mixed in a water-based solution, desirably a water-based solution containing a base, to cause hexagonal ferrite precursor containing the atoms contained in the above salts to precipitate out. Normally; salts (such as hydroxides) containing iron atoms, divalent metal atoms, and rare earth atoms precipitate out of the water-based solution as particles, desirably colloidal particles. The particles that precipitate out can convert to ferrite and become hexagonal ferrite when subsequently placed in the presence of high-temperature, high-pressure water. Conducting this mixing in the presence of a base is presumed to primarily cause the hydroxide ions (OH⁻) in the water-based solution containing a base to form a hydroxide sol with ions derived from the above salts, thereby forming a precursor. The precursor that precipitates out can be subsequently converted (to ferrite) and become hexagonal ferrite.

In the present invention and present specification, the base refers to one or more bases as defined by one or more among Arrhenius, Bronsted, or Lewis (Arrhenius bases, Bronsted bases, or Lewis bases).

Specific examples of bases are sodium hydroxide, potassium hydroxide, sodium carbonate, and ammonia water. However, there is no limitation thereto. Nor is there a limitation to inorganic bases; organic bases can also be employed. From the perspective of the ease of manufacturing an ellipsoidal powder in the form of hexagonal ferrite powder, the quantity of base as a molar ratio is desirably greater than or equal to 1, and preferably greater than or equal to 2, as the proportion of base relative to the combined total of iron salt and divalent metal salt. From the same perspective, this molar ratio of the quantity of base is desirably less than or equal to 5, preferably less than or equal to 4. The temperature of the water-based solution during the reaction can be controlled by heating and/or cooling, or can be room temperature with no temperature regulation. Desirably; the liquid temperature falls within a range of 10° C. to 90° C. The reaction will progress adequately without temperature regulation (for example, at about 20° C. to 25° C.). To control the temperature, the reaction tank, described further below, can be equipped with a heating means and/or cooling means. The feed passage, described further below, can be heated by a heating means or cooled by a cooling means to control the temperature.

The water-based solvent refers to solvent containing water. Water alone will do, as will a mixed solvent of water and an organic solvent. The water-based solvent that is employed to prepare the precursor desirably contains equal to or more than 50 weight percent of water, and is preferably water alone.

The organic solvent that can be employed in combination with water in the water-based solvent is desirably one that is miscible with water or that s hydrophilic. From this perspective, the use of a polar solvent is suitable. The term “polar solvent” refers to solvent that satisfies at least either having a dielectric constant of equal to or higher than 15 or having a solubility parameter of equal to or higher than 8. Desirable examples of organic solvents are alcohols, ketones, aldehydes, nitriles, lactams, oximes, amides, ureas, sulfides, sulfoxides, phosphoric acid esters, carboxylic acids, esters derived from carboxylic acids, carbonic acid or carbonic acid esters, and ethers.

(iv) Mixing the various components

In one embodiment, mixing of the various components to prepare a hexagonal ferrite precursor can be conducted in a reaction tank. The reaction tank employed can be a batch-type reaction tank or a continuous-type reaction tank. In a batch-type reaction tank, feeding the starting materials, reacting them, and removing the reaction products are conducted in different steps. By contrast, in a continuous-type reaction tank, feeding of the starting materials and reacting them are conducted in parallel with removing the reaction product at least some portion of the time. Regardless of whether batch-type or continuous-type, the water-based solution containing the above components and a water-based solvent is normally stirred and mixed with a known stirring means such as stirring blades or a magnetic stirrer in the reaction tank. The various components such as starting materials and the base can be fed as solids or as liquids into the reaction tank. The concentration of starting materials and base in the water-based solution can be suitably set. Further, the various components can be simultaneously fed into the reaction tank, or feeding can be sequentially started in any order. A water-based solution containing hexagonal ferrite precursor can be obtained in this manner. The water-based solution containing the hexagonal ferrite precursor will also be referred to as the “precursor solution” hereinafter,

In another embodiment,mixing of the above components to prepare a water-based solution (precursor solution) containing hexagonal ferrite precursor can be conducted in a continuous manufacturing process. Desirably, a water-based solution containing a hexagonal ferrite precursor can be prepared by merging a feed passage feeding a solution containing an iron salt, divalent metal salt, and rare earth salt with a feed passage feeding a base-containing water-based solution to mix the solutions. Specific embodiments of such preparation will be described further below.

In methods of manufacturing hexagonal ferrite powder employing a hydrothermal synthesis method, the practice in recent years has been to mix an organic compound commonly referred to as an organic modifier with hexagonal ferrite precursor prior to preparing hexagonal ferrite, or to prepare a hexagonal ferrite precursor containing this organic compound. In one embodiment, such an organic modifier can be used to manufacture the hexagonal ferrite powder according to an aspect of the present invention. The organic modifier is said to contribute to controlling the shape and the like of the hexagonal ferrite powder being prepared. Reference can be made to known techniques regarding methods of manufacturing hexagonal ferrite powder employing hydrothermal synthesis methods using organic modifiers.

Additionally, in a desirable embodiment of the present invention, the hexagonal ferrite can be prepared as described in detail below, without using such an organic modifier. The present inventor presumes that using a rare earth salt together with an iron salt and a divalent metal salt can cause rare earth atoms to be locally present in the surface layer portion of the hexagonal ferrite precursor, with the locally present rare earth atoms contributing to controlling the shape in the manner as an organic modifier. Accordingly, the hexagonal ferrite powder according to an aspect of the present invention can be manufactured without employing an organic modifier.

<Preparation of Hexagonal Ferrite

Hexagonal ferrite can be prepared by continuously feeding precursor solution to a reaction flow path in which the fluid flowing through the interior thereof is heated and pressurized to convert the hexagonal ferrite precursor to hexagonal ferrite within the reaction flow path. The present inventor presumes that once the hexagonal ferrite precursor has been instantaneously dissolved within the reaction flow path (high-temperature, high-pressure system), it can crystallize, causing hexagonal ferrite particles to precipitate out (convert to hexagonal ferrite).

In one embodiment, the precursor solution is continuously fed as is to a reaction flow path in which the fluid flowing through the interior thereof is heated and pressurized. In such an embodiment, the water contained in the precursor solution can be heated and pressurized, putting the hexagonal ferrite precursor in the presence of high-temperature, high-pressure water and converting the hexagonal ferrite precursor to hexagonal ferrite.

In one embodiment, the precursor solution is merged with a feed passage through which high-temperature, high-pressure water is being fed, after which it can be continuously fed to a reaction flow path in which the fluid flowing through the interior thereof is heated and pressurized to convert the hexagonal ferrite precursor o hexagon ferrite within the reaction flow passage.

The latter embodiment is desirable in that, since the hexagonal ferrite precursor can be brought into contact with high-temperature, high-pressure water to rapidly place it in a highly reactive state, the conversion to hexagonal ferrite can proceed rapidly. A more specific description of the latter embodiment will be given below with reference to the drawings. However, the present invention is not limited to the embodiments shown in the drawings.

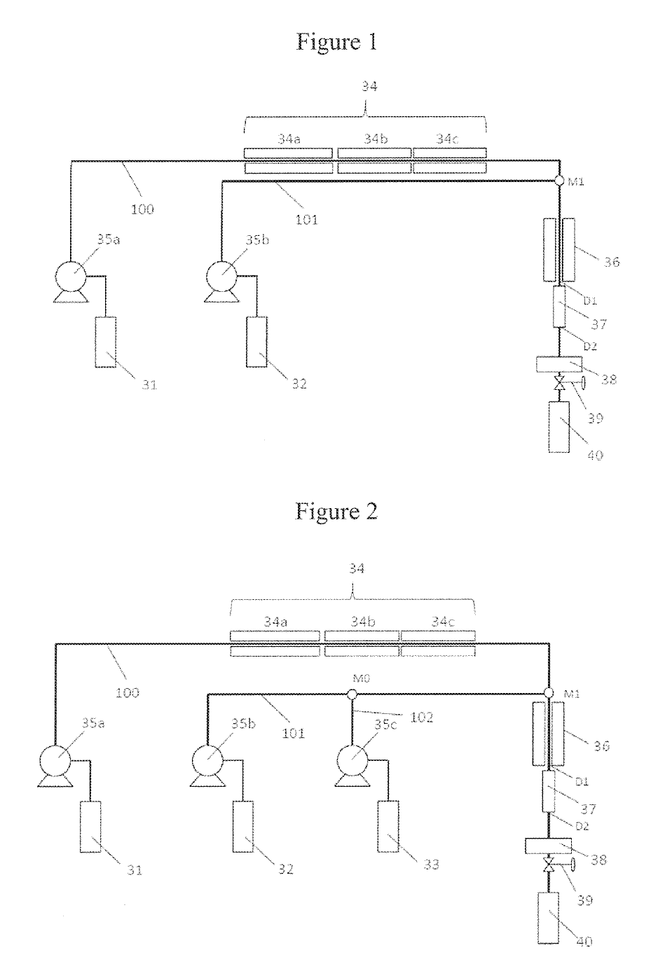

FIG. 1 is a schematic descriptive drawing of an example of a manufacturing device that can be used to manufacture hexagonal ferrite powder by a hydrothermal synthesis method, and more specifically, a schematic descriptive drawing of a manufacturing device that can be used to manufacture hexagonal ferrite powder by continuously conducting a hydrothermal synthesis method (continuous hydrothermal synthesis method).

FIG. 2 is a schematic descriptive drawing of an example of a manufacturing device suited to conducting preparation of precursor (precursor solution) also in a continuous manufacturing method.

Identical constituent elements are denoted by identical symbols in FIGS. 1 and 2.

By way of example, FIG. 1 will be described. The manufacturing device of FIG. 1 has liquid tanks 31 and 32, heating means 34 (34a to 34c), liquid pressurizing and heating means 35a and 35b, a reactive flow path 36, a cooling element 37, a filtering means 38, a pressure regulating valve back pressure valve) 39, and a recovery element 40. Fluids are fed from various liquid tanks to feed passage 100 and flow path 101. The number (3) of heating means shown in the figures is merely an example and is not a limitation.

In the manufacturing device shown in FIG. 2, a liquid tank 33, a liquid pressurizing and feeding means 35c, and a flow path 102 are contained in addition to the above configuration.

In one embodiment, water such as pure water or distilled water is introduced into liquid tank 31, and precursor solution is introduced into liquid tank 32. The water that is introduced into liquid tank 31 is fed into feed passage 100 while being pressurized by liquid pressurizing and feeding means 35a, and is heated by heating means 34. This heating and pressurizing is conducted to put the water in a high-temperature, high-pressure state, and desirably to put the water in a subcritical to supercritical state. Water in a subcritical to supercritical state can exhibit extremely high reactivity. Thus, putting the hexagonal ferrite precursor into contact with water in such a state can instantaneously place the water in a highly reactive state, allowing the conversion to ferrite to rapidly progress. Generally, heating water to greater than or equal to 200° C. and pressurizing it to greater than or equal to 20 MPa can produce a subcritical to supercritical state. Accordingly, the water is desirably heated to a temperature of greater than or equal to 200° C. and pressurized to a pressure of greater than or equal to 20 MPa. The high-temperature, high-pressure water that has been heated and pressurized is fed into feed passage 100, reaching mixing element M1.

In the manufacturing device shown in FIG. 1, the precursor solution is fed from liquid tank 32 by liquid pressurizing and feeding means 35b to pipe 101, merging in mixing element M1 with feed passage 100 that is feeding high-temperature, high-pressure water.

In the manufacturing device shown in FIG. 2, precursor solution can also be prepared by a continuous manufacturing method. In the manufacturing device shown in FIG. 2, a solution containing an iron salt, divalent metal salt, and rare earth salt (also referred to as a “starting material solution” hereinafter) is introduced into liquid tank 32 and a base-containing water-based solution (normally, not containing an iron salt, divalent metal salt, and rare earth salt) is introduced into liquid tank 33. Starting material solution that has been fed from liquid tank 32 by liquid pressurizing and feeding means 35b to pipe 101 and base-containing water-based solution that has been fed from liquid tank 33 by liquid pressurizing and feeding means 35c to pipe 102 are merged in mixing element M0. As the reverse of this example, a base-containing water-based solution can be introduced to liquid tank 32 and a starting material solution can be introduced to liquid tank 33. By mixing the starting material solution and base-containing water-based solution between mixing elements M0 to M1, it is possible to prepare hexagonal ferrite precursor.

In the manufacturing device shown in FIG. 2, a water-based solution containing the hexagonal ferrite precursor thus prepared is merged in mixing element M1 with high-temperature, high-pressure water that has been fed from liquid tank 31 by liquid pressurizing and feeding means 35a to feed passage 100 and heated by heating means 34.

Following mixing in the above mixing element., the mixed flow of high-temperature, high-pressure water and hexagonal ferrite precursor is fed over feed passage 100 to reaction flow path 36. The mixed flow in reaction flow path 36 is heated, as well as pressurized by pressurizing means 35a, to place the water contained in the mixed flow within reaction flow path 36 into a high-temperature, high-pressure state, desirably a subcritical to supercritical state. Ferrite conversion of the hexagonal ferrite precursor can progress. Subsequently, the solution containing particles of hexagonal ferrite converted from hexagonal ferrite precursor is discharged through discharge outlet D1. The discharged solution is ted to cooling element 37 and cooled by cooling element 37. Subsequently, it passes through discharge outlet D2 and the particles of hexagonal ferrite are captured by a filtering means (such as a filter) 38. The hexagonal ferrite particles that have been captured by filtering means 38 are released from filtering means 38, pass through pressure regulating valve 39, and are recovered in recovery element 40. The hexagonal ferrite powder that has been recovered is collected. As needed, known post-processing such as washing (for example, washing such as acid washing, water washing, washing using solvent, and the like) and centrifugation can be conducted to obtain hexagonal ferrite powder. From the perspective of inhibiting the diffusion of rare earth atoms within the particles of hexagonal ferrite, the hexagonal ferrite powder is desirably not placed in an environment with an atmospheric temperature of greater than or equal to 300° C. during post-processing,

With regard to heating and pressurizing in reaction flow path 36, heating a reaction system in which water is present to greater than or equal to 300° C. and pressurizing it to greater than or equal to 20 MPa can put the water in a subcritical to supercritical state and can create a reaction field that is extremely reactive. By placing hexagonal ferrite precursor in such a state, it is possible to cause the conversion to ferrite to progress rapidly and obtain hexagonal ferrite particles. Accordingly, the heating temperature is desirably a temperature that renders the mixed flow within the reaction flow path greater than or equal to 300° C. It is preferable for the heating temperature to be set such that the liquid temperature of the water-based solution discharged by the reaction flow path and fed to the cooling element is greater than or equal to 350° C. but less than or equal to 450° C. Here, the liquid temperature refers to the liquid temperature at the discharge outlet of the reaction flow path (discharge outlet D1 in the device shown in FIGS. 1 and 2). Conducting the reaction converting hexagonal ferrite precursor to hexagonal ferrite in the reaction flow path under temperature conditions where the liquid temperature at the discharge outlet of the reaction flow path falls within this range is desirable from the perspective of improving the magnetic characteristics of the hexagonal ferrite powder obtained. The present inventor presumes this to be due to improved crystallinity of the hexagonal ferrite powder. The liquid temperature is preferably greater than or equal to 360° C. but less than or equal to 430° C., and more preferably greater than or equal to 380° C. but less than or equal to 420° C. Additionally, the pressure that is applied to the mixed flow in the reaction flow path is desirably greater than or equal to 20 MPa, preferably falling within a range of 20 MPa to 50 MPa.

The period from when a given position in the mixed flow enters the reaction flow path to when it is discharged will be referred to as the “reaction time.” Based on research conducted by the present inventor, a tendency has been observed whereby the longer the reaction time, although advantageous to the formation of hexagon ferrite crystals, the greater the proportion of particles not satisfying equation (1) and/or plate-like particles accounted for in the hexagonal ferrite powder being prepared became. From the perspective of the ease of manufacturing hexagonal ferrite powder in the form of ellipsoidal powder, the reaction time is desirably 30 seconds to 3 minutes, preferably 40 seconds to 2 minutes, and more preferably, 50 seconds to 2 minutes. The reaction time can be adjusted by means of either, or both, the dimensions of the reaction flow path (such as the length of the flow path) and the speed of the mixed flow within the reaction flow path. Further, the activation volume of the hexagonal ferrite powder can be controlled by means of the reaction time. From the perspective of the ease of manufacturing of hexagonal ferrite powder having an activation volume within the above range, the reaction time desirably falls within the stated range.

The water-based solution that has been discharged from the reaction flow path as set forth above can be cooled in a cooling element. Cooling in the cooling element can completely stop the reaction converting hexagonal ferrite precursor o hexagonal ferrite. This is desirable to obtain hexagonal ferrite powder with little variation in particle size. To that end, the cooling in the cooling element is desirably conducted so that the liquid temperature of the water-based solution within the cooling element is less than or equal to 100° C., and preferably conducted so that the cooling temperature is greater than or equal to room temperature (about 20° C. to 25° C.) but less than or equal to 100° C. Cooling can be conducted by a known cooling means such as a water cooling device cooling the interior by circulating cold water, for example. Normally, pressure identical to that applied to the liquid feeding path and reaction flow path is applied to the aqueous solution within the cooling element.

For example, the pH of the water-based solution after cooling can be greater than or equal to 6.00 but less than or equal to 14.00. The “pH Of the water-based solution after cooling” refers here to the pH of the water-based solution that has been discharged from the reaction flow path and discharged from the discharge outlet of the cooling element. It is a value that is measured by recovering at some position at least a portion of the water-based solution that has been discharged through the discharge outlet, adjusting it to a liquid temperature of 25° C., and measuring the pH. For example, in the embodiment shown in FIGS. 1 and 2, it is the pH of the water-based solution that has been discharged through discharge outlet D2. The pH can be, for example, that obtained by collecting a portion of the water-based solution that has passed through pressure regulating valve 39 and recovered in recovery element 40, adjusting it to a liquid temperature of 25° C., and measuring the pH. Normally, components that alter the pH of the water-based solution are normally not added in the cooling element. Accordingly, the pH of the water-based solution following cooling can be the same as, or can correlate with, the pH of the reaction system within the reaction flow passage where the reaction converting hexagonal ferrite precursor to hexagonal ferrite is conducted. Based on research by the present inventor, a tendency was observed where the higher the pH of the water-based solution following cooling, although advantageous to the formation of hexagonal ferrite crystals, the greater the proportion of particles not satisfying equation (1) and/or plate-like particles accounted for in the hexagonal ferrite powder being prepared became. From the perspective of the ease of manufacturing hexagonal ferrite powder in the form of ellipsoidal powder, the pH of the water-based solution following cooling desirably falls within a range of 10.0 to 14.0, preferably within a range of 10.5 to 13.8, and more preferably, within a range of 11.0 to 13.5. The pH of the water-based solution following cooling, or in other words, the pH of the reaction system within the reaction flow path where the reaction converting hexagonal ferrite precursor to hexagonal ferrite is conducted, can be adjusted by, for example, employing a base during preparation of the hexagonal ferrite precursor. Adjustment is also possible by mixing hexagonal ferrite precursor and a base at any stage.

In the manufacturing method set forth above, it is desirable to employ high pressure-use metal piping as the feed passages and flow paths (also referred to as “piping” hereinafter) to apply pressure to the fluids that are fed through the interior. The metal constituting the piping is desirably SUS (Special Use Stainless Steel) 316, SUS 304, or some other stainless steel, or a nickel-based alloy such as Inconel (Japanese registered trademark) or Hastelloy (Japanese registered trademark) because of their low-corrosion properties. However, there is no limitation thereto. Equivalent or similar materials can also be employed. The piping of laminate structure described in Japanese Unexamined Patent Publication (KOKAI) No. 2010-104928, which is expressly incorporated herein by reference in its entirety, can also be employed.

In the manufacturing devices shown in FIGS. 1 and 2, the various mixing elements have structures such that pipes are joined by T-joints. The reactors described in Japanese Unexamined Patent Publication (KOKAI) Nos. 2007-268503, 2008-12453, 2010-75914, and the like, which are expressly incorporated herein by reference in their entirety, can be employed as the mixing elements. The material of the reactor is desirably the material described in Japanese Unexamined Patent Publication (KOKAI) No. 2007-268503, 2008-12453, or 2010-75914, which are expressly incorporated herein by reference in their entirety. Specifically, the metals set forth above as being suitable for constituting piping are desirable. However, there is no limitation thereto, and equivalent or similar materials can be employed. Combination with low-corrosion titanium alloys, tantalum alloy, ceramics and the like is also possible.

Specific embodiments of a method of manufacturing hexagonal ferrite powder according to an aspect of the present invention have been described above. However, the hexagonal ferrite powder according to an aspect of the present invention is not limited to hexagonal ferrite powder manufactured by such specific embodiments.

### Magnetic Recording Medium

An aspect of the present invention relates to a magnetic recording medium having a magnetic layer containing ferromagnetic powder and binder on a nonmagnetic support, in which the ferromagnetic powder is the above hexagonal ferrite powder.

The above magnetic recording medium will be described in greater detail below.

<Magnetic Layer>

Details regarding the ferromagnetic powder (hexagonal ferrite powder) contained in the magnetic layer are as set forth above.

The magnetic layer contains ferromagnetic powder and binder. Polyurethane resins, polyester resins, polyamide resins, vinyl chloride resins, acrylic resins such as those provided by copolymerizing styrene, acrylonitrile, methyl methacrylate and the like, cellulose resins such as nitrocellulose, epoxy resins, phenoxy resins, polyvinylacetal, polyvinylbutyral, and other polyvinyl alkylal resins can he employed singly, or as mixtures of multiple resins, as the binder contained in the magnetic layer. Among these, desirable resins are polyurethane resin, acrylic resins, cellulose resins, and vinyl chloride resins. These resins can also be employed as binders in the nonmagnetic layer and/or backcoat layer described further below. Reference can be made to paragraphs 0029 to 0031 of Japanese Unexamined Patent Publication (KOKAI) No. 2010-24113, which is expressly incorporated herein by reference in its entirety, with regard to the above binders. Polyisocyanate curing agents can also be employed in any content with the above resin.

Additives can be added to the magnetic layer as needed. Examples of additives are abrasives, lubricants, dispersing agents, dispersion adjuvants, fungicides, antistatic agents, oxygen inhibitors, and carbon black. The additives described above can be suitably selected for use from among commercial products based on the properties that are desired.

<Nonmagnetic Layer>

The nonmagnetic: layer will be described next. The magnetic recording medium according to an aspect of the present invention can have a magnetic layer directly on a nonmagnetic support, or can have a nonmagnetic layer containing nonmagnetic powder and binder between the nonmagnetic support and the magnetic layer. The nonmagnetic powder that is employed in the nonmagnetic layer can be an organic or an inorganic material. Carbon black and the like can also be employed. Examples of inorganic materials are metals, metal oxides, metal carbonates, metal sulfates, metal nitrides, metal carbides, and metal sulfides. Nonmagnetic powders of these materials are available as commercial products and can be manufactured by known methods. For details, reference can be made to paragraphs 0036 to 0039 of Japanese Unexamined Patent Publication (KOKAI) No. 2010-24113.

Known techniques with regard to magnetic layer and/or nonmagnetic layer can he applied for binders, lubricants, dispersing agents, additives, solvents, dispersion methods, and the like of the nonmagnetic layer. Carbon black and/or organic material powders can also be added to the nonmagnetic layer. In this regard, by way of example, reference can be made to paragraphs 0040 to 0042 of Japanese Unexamined Patent Publication (KOKAI) No. 2010-24113.

<Nonmagnetic support>

Examples of nonmagnetic supports (also simply referred to as “supports”, hereinafter) are known supports such as biaxially stretched polyethylene terephthalate, polyethylene naphthalate, polyamide, polyamide-imide, and aromatic polyamide. Among these, polyethylene terephthalate, polyethylene naphthalate, and polyamide are desirable. These supports can be subjected in advance to corona discharge, plasma treatment, adhesion-enhancing treatment, heat treatment, or the like.

<Thickness of Nonmagnetic Support and Various Layers>

The thickness of the nonmagnetic support and the various layers is as follows.

The thickness of the nonmagnetic support is desirably 3 μm to 80 μm. The thickness of the magnetic layer, which can be optimized based on the saturation magnetization level of the magnetic head employed, the head gap length, and the bandwidth of the recording signal, is generally 10 nm to 150 nm, desirably 20 nm to 120 nm, and preferably, 30 nm to 100 nm. It suffices for the magnetic layer to comprise at least one layer. The magnetic layer can he divided into two or more layers having different magnetic characteristics, and known configurations relating to multilayer magnetic layers can be applied. For a multilayer magnetic layer, the thickness of the magnetic layer refers to the combined thickness of the multiple magnetic layers.

The thickness of the nonmagnetic layer is, for example, 0.1 μm to 3.0 μm, desirably 0.1 μm to 2.0 μm, and preferably, 0.1 μm to 1.5 μm. The nonmagnetic layer of the above magnetic recording medium includes substantially nonmagnetic layers, for example, containing small quantities of ferromagnetic powder, either as impurities or intentionally, in addition to nonmagnetic powder. The term “substantially nonmagnetic layer” refers to a layer in which the residual magnetic flux density is less than or equal to 10 mT, or the coercive force is less than or equal to 7.96 kA/m (100 Oe), or the residual magnetic flux density is less than or equal to 10 mT and the coercive force is less than or equal to 7.96 kA/n (100 Oe). The nonmagnetic layer desirably has no residual magnetic flux density or coercive force,

<Backcoat Layer>

The above magnetic recording medium can have a backcoat layer on the opposite surface of the nonmagnetic support from the surface on which the magnetic layer is present. The backcoat layer is a layer that contains nonmagnetic powder and binder. The nonmagnetic powder is desirably in the form of carbon black and/or an inorganic powder. Known techniques with regard to magnetic layer, nonmagnetic layer and backcoat layer can be applied to the binders and various additives for forming the backcoat layer. The thickness of the backcoat layer is desirably less than or equal to 0.9 μm and preferably 0.1 μm to 0.7 μm.

<Manufacturing Method>

The process of preparing the compositions for forming the various layers such as the magnetic layer, nonmagnetic layer and backcoat layer normally contains at least a kneading step, dispersion step, and mixing steps that are provided as needed before and after these steps. Each of these steps can be divided into two or more stages. Various components can be added at the outset, or in the course of, any step. Individual components can be divided and added during two or more steps. For example, binder can be divided and added at the kneading step, dispersion step, and mixing step for adjusting the viscosity after the dispersion. Manufacturing techniques that have been conventionally known can be applied. A powerful kneading device, such as an open kneader, continuous kneader, pressurized kneader, or extruder is desirably employed in the kneading step. Details of these kneading processes are given in Japanese Unexamined Patent Publication (KOKAI) Nos. Heisei 1-106338 and 1-79274, which are expressly incorporated herein by reference in their entirety. Glass beads and other types of beads can be employed to disperse the various layer-forming compositions. High specific gravity dispersion beads in the form of zirconia beads, titania beads, and steel beads are suitable as such dispersion beads. These dispersion beads can be employed by optimizing their diameters (bead diameter) and fill rates. A known dispersion apparatus can be employed.

Reference can be made to paragraphs 0051 to 0057 of Japanese Unexamined Patent Publication (KOKAI) No. 2010-24113, for details regarding the manufacturing method of the magnetic recording medium.

Incorporating the hexagonal ferrite powder according to an aspect of the present invention into the magnetic layer of the magnetic recording medium according to an aspect of the present invention that has been set forth above can achieve good electromagnetic characteristics and permit reproduction at high output even with repeated reproduction. Accordingly, the magnetic recording medium according to an aspect of the present invention is suitable as a magnetic recording medium for high-density recording requiring highly reliable reproduction capability over extended periods.

### EXAMPLES

The present invention will be described in greater detail below through Examples. However, the present invention is not limited to the embodiments given in Examples. The “parts” and “% (percent)” given below are “weight parts” arid “weight %” unless specifically stated otherwise. Unless specifically stated otherwise, the processes and evaluation given below were conducted in the atmosphere at 23° C.±1° C. (room temperature).

### [Example 1]

### (1) Preparation of Precursor Solution

Hexagonal ferrite precursor was prepared by the following method in a batch-type reaction tank equipped with stirring blades and a precursor solution (precursor-containing solution) was obtained,

In the reaction tank, barium hydroxide (Ba(OH)₂.SH₂O), iron(III) nitrate (Fe(NO₃)₃.9H₂O), and the rare earth nitrate indicated in Table 2 were dissolved in pure water. While conducting continuous stirring with the stirring blades, potassium hydroxide KOH was added dropwise to the reaction tank to a concentration in the aqueous solution concentration of 0.2 mol/L (dropwise addition rate: 10 cm³/minute) to prepare a hydroxide sol (precursor-containing aqueous solution). The combined Ba and Fe concentration in the precursor-containing aqueous solution as calculated from the quantity of barium hydroxide and iron nitrate employed was 0.075 mol/L and the Ba/Fe molar ratio was 0.5. The molar ratio (M/Fe) of rare earth atoms and iron atoms in the precursor-containing aqueous solution as calculated from the quantity of rare earth nitrate and iron nitrate employed was 1.5.

(2) Preparation of Hexagonal Ferrite Employing Continuous Hydrothermal Synthesis Method

The precursor-containing aqueous solution (hydroxide sol) that was prepared in (1) above was introduced into the liquid tank 32 of the manufacturing device shown in FIG. 1. SUS316BA tube was employed for the piping of the manufacturing device. High-temperature, high-pressure water was passed through pipe 100 by heating pure water that had been introduced into liquid tank 31 with a heating means (heater) 34 while feeding it with a liquid pressurizing and feeding means (high-pressure pump) 35a. In this process, the temperature and pressure were controlled so that the temperature of the high-temperature, high-pressure water after passing through heating means 34c was 450° C. and the pressure was 30 MPa.

The precursor-containing aqueous solution (hydroxide sol) was fed with a liquid pressurizing and feeding means (high-pressure pump 35b) to pipe 101 at a liquid temperature of 25° C. and mixed in mixing element M1 with the high-temperature, high-pressure water. Then, the liquid flowing through the interior was heated to a temperature of 400° C. (the liquid temperature at discharge outlet D1) and pressurized to a pressure of 30 MPa in reaction flow path 36 to synthesize (convert the precursor to) hexagonal ferrite (barium ferrite). Subsequently, the liquid containing the hexagonal ferrite particles was discharged from reaction flow path 36, cooled to a liquid temperature of less than or equal to 100° C. in cooling element 37 equipped with a water cooling mechanism, passed through pressure regulating valve 39, and recovered in recovery element 40. The recovered powder was washed with an acetic acid aqueous solution (0.2 mol/L) and then centrifuged to separate out the hexagonal ferrite powder.

The reaction time in the reaction flow path was 60 seconds portion of the liquid recovered in recovery element 40 that had been discharged through discharge outlet D2 of the manufacturing device shown in FIG. 1 was collected and adjusted to a liquid temperature of 25° C. Measurement of the pH with a pH meter (portable pH meter, D series, made by Horiba) revealed pH 11.0 (the pH of the aqueous solution following cooling).

### Examples 2 to 14

### Comparative Examples 1, 2, 6 and 7

With the exception that at least one from among the type of rare earth salt added during the preparation of precursor solution, the quantity added (M/Fe molar ratio), and the reaction time in the reaction flow path was changed, hexagonal ferrite powder was obtained by the same method as in Example 1. The M/Fe molar ratio and reaction time are given in Table 1. The reaction time was adjusted by using reaction flow paths of different lengths from that of reaction flow path 36.

### Example 15

With the exception that strontium hydroxide (Sr(OH)₂.8H₂O) was employed instead of barium hydroxide as the divalent metal salt, hexagonal ferrite powder was obtained by the same method as in Example 1.

### Comparative Example 3

With the exception that no rare earth salt was added during preparation of the precursor solution, hexagonal ferrite powder was obtained by the same method as in Example

### Comparative Example 4

An aqueous solution of a rare earth nitrate (see Table 2) was added to hexagonal ferrite powder obtained by the same method as in Comparative Example 3. The molar ratio (M/Fe) of rare earth atoms and iron atoms calculated from the quantity of iron nitrate and rare earth nitrate employed in the preparation of the precursor solution was the value given in Table 1. After stirring for 10 minutes, 0.3 L of an 8 mol/L sodium hydroxide aqueous solution was added and the mixture was stirred for another 30 minutes. The temperature was then raised to a liquid temperature of 80° C. and stirring was conducted for another 3 hours to conduct a reaction to surface treat e hexagonal ferrite powder. The reaction product obtained was washed with water to a pH of less than or equal to 12.0, filtered, dried, and comminuted to obtain hexagonal ferrite powder.

### Comparative Example 5

Hexagonal ferrite powder obtained by the same method as in Example 2 was subjected to a heat treatment for 5 hours in a heating furnace at an atmospheric temperature of 550° C.

### Comparative Example 8

### (1) Preparation of Precursor Solution

An aqueous solution (sol) containing hexagonal ferrite precursor was prepared by dissolving barium salt in the form of barium hydroxide (Ba(OH)₂.8H₂O), iron salt in the form of iron(III) nitrate (Fe(NO₃)₃.9H₂O), and potassium hydroxide in pure water. In this process the quantity of potassium hydroxide added was set so that the molar ratio of potassium hydroxide to the combined total of the barium salt and iron salt was 3, and the potassium hydroxide concentration in the precursor solution was 0.15 mol/L. The concentration of the precursor in the precursor solution prepared was 0.05 mol/L, and the Ba/Fe molar ratio was 0.5.

(2) Preparation of Organic Compound Solution

Sodium oleate was dissolved in pure water to prepare an organic compound solution. The sodium oleate concentration of the solution prepared was 0.1 mol/L.

(3) Preparation of Hexagonal Ferrite Using a Continuous Hydrothermal Synthesis Method

The aqueous solution (sol) that had been prepared in (1) above was introduced into liquid tank 32 of the manufacturing device shown in FIG. 2 and the organic compound solution that had been prepared in (2) above was introduced into liquid tank 33. SUS316BA tube was employed as the pipe in the manufacturing device.

The pure water that had been introduced into liquid tank 31 was heated by a heating means (heater) 34 while being fed by a liquid pressurizing and feeding means (high-pressure pump) 35a to cause high-temperature, high-pressure water to pass through pipe 100. In this process, the temperature and the pressure were controlled so that the temperature of the high-temperature, high-pressure water within the liquid feed path after passing through heating means 34c was 350° C., and the pressure was 30 MPa.

The precursor solution and the organic compound solution were respectively fed to pipes 101 and 102 at a liquid temperature of 25° C. with liquid pressurizing and feeding means (high-pressure pumps) 35b and 35c and merged in mixing element M0 so that the ratio by volume was precursor solution: organic compound solution=50: 50. The mixed solution obtained was merged with high-temperature, high-pressure water in mixing element M1. Next, hexagonal ferrite (barium ferrite) was synthesized (the precursor was converted) by synthesizing hexagonal ferrite by heating the liquid flowing through the interior to a temperature of 400° C. (the liquid temperature at discharge outlet D1) and pressurizing it to a pressure of 30 MPa. The reaction time in the reaction flow path was 60 seconds.

Subsequently, the liquid containing hexagonal ferrite particles was discharged from reaction flow path 36 and cooled to a liquid temperature of less than or equal to 100° C. in cooling element 37 equipped with a water cooling mechanism. It passed through pressure regulating valve 39 and was recovered in recovery element 40. The powder that was recovered was washed with ethanol and then centrifuged to separate out the hexagonal ferrite powder.

TABLE 1

| | Nitrate of | |
|---|---|---|
| | rare earth M | |
| | Quantity added | Reaction time |
| | M/Fe mol % | sec |
| Ex. 1 | 1.5 | 60 |
| Ex. 2 | 5.0 | 60 |
| Ex. 3 | 6.5 | 60 |
| Ex. 4 | 7.5 | 60 |
| Ex. 5 | 1.0 | 60 |
| Ex. 6 | 0.6 | 60 |
| Comp. Ex. 1 | 0.4 | 60 |
| Comp. Ex. 2 | 10.0 | 60 |
| Comp. Ex. 3 | — | 60 |
| Comp. Ex. 4 | 6.6 | 60 |
| Comp. Ex. 5 | 5.0 | 60 |
| Ex. 7 | 5.0 | 80 |
| Ex. 8 | 5.0 | 70 |
| Ex. 9 | 5.0 | 50 |
| Ex. 10 | 5.0 | 40 |
| Comp. Ex. 6 | 5.0 | 30 |
| Comp. Ex. 7 | 5.0 | 120 |
| Comp. Ex. 8 | — | 60 |
| Ex. 11 | 5.0 | 60 |
| Ex. 12 | 5.0 | 60 |
| Ex. 13 | 5.0 | 60 |
| Ex. 14 | 5.0 | 60 |
| Ex. 15 | 5.0 | 60 |

[Powder Evaluation Methods]

### 1. X-Ray Diffraction Analysis

X-ray diffraction analysis of sample powder collected from powder fabricated in Examples and Comparative Examples confirmed that it was hexagonal ferrite (magnetoplumbite type). In Table 2 below, BaFe denotes barium ferrite and SrFe denotes strontium ferrite.

### 2. Observation of Particle Form

500 particles were randomly extracted from each of the hexagonal ferrite powders fabricated in Examples and Comparative Examples and the ratio of the 500 particles accounted for by particles that satisfied equation (I) and were not plate-shaped was calculated by the method set forth above employing a model H-9000 transmission electron microscope made by Hitachi as a transmission electron microscope and employing image analysis software in the form of the image analysis software KS-400 put out by Carl Zeiss.

### 3. Surface Layer Portion Content, Bulk Content, and Surface Layer Portion Content/Bulk Content of Rare Earth Atoms

A 12 mg quantity of sample powder was collected from each of the hexagonal ferrite powders fabricated in Examples and the Comparative Examples. This sample powder was partially dissolved under the dissolution conditions given by way of example above to obtain a filtrate. The filtrate obtained was subjected to elemental analysis with an ICP analyzer to determine the content of rare earth atoms in the surface layer portion.

Separately, a 12 mg quantity of sample powder was collected from each of the hexagonal ferrite powders fabricated in Examples and the Comparative Examples. This sample powder was fully dissolved under the dissolution conditions given by way of example above to obtain a filtrate. The filtrate obtained was subjected to elemental analysis with an ICP analyzer to determine the bulk content of rare earth atoms.

The “surface layer portion content/bulk content” was calculated from the values obtained.

The lack of a localized presence of rare earth atoms in the surface portion of the hexagonal ferrite powder of Comparative Example 5 was attributed to the heat treatment causing the rare earth atoms that had been locally present in the surface portion to diffuse into the interior.

### 4. Activation Volume and Anisotropy Constant

Sample powder was collected from each of the hexagonal ferrite powders fabricated in Examples and Comparative Examples. A vibrating sample magnetometer (made by Toei-Kogyo) was employed to determine the activation volume and anisotropy constant by the method set forth above.

[Fabrication of Magnetic Recording Medium (Magnetic Tape)]

### (1) Formula of Magnetic Layer Composition

### (Magnetic Liquid)

| | |
|---|---|
| Ferromagnetic powder (powder prepared in above | 100.0 parts |
| Examples or Comparative Examples): | |
| SO₃Na group-containing polyurethane resin: | 14.0 parts |

(weight average molecular weight: 70,000, SO₃Na groups: 0.4 meq/g)

| | |
|---|---|
| Cyclohexanone: | 150.0 parts |
| Methyl ethyl ketone: | 150.0 parts |

### (Abrasive Liquids)

| | |
|---|---|
| Abrasive liquid A Alumina abrasive (average particle | 3.0 parts |
| size: 100 nm): | |
| Sulfonic acid group-containing polyurethane resin: | 0.3 part |

(weight average molecular weight: 70,000, SO₃Na groups: 0.3 meq/g)

| | | |
|---|---|---|
| Cyclohexanone: | 26.7 | parts |
| Abrasive liquid B Diamond abrasive (average particle | 1.0 | part |
| size: 100 nm): | | |
| Sulfonic acid group-containing polyurethane resin: | 0.1 | part |

(weight average molecular weight: 70,000, SO₃Na groups: 0.3 meq/g)

| | |
|---|---|
| Cyclohexanone: | 26.7 parts |

### (Silica Sol)

| | |
|---|---|
| Colloidal silica (average particle size: 100 nm): | 0.2 part |
| Methyl ethyl ketone: | 1.4 part |

### (Other Components)

| | |
|---|---|
| Stearic acid: | 2.0 parts |
| Butyl stearate: | 6.0 parts |
| Polyisocyanate (Coronate made by Nippon Polyurethane | 2.5 parts |
| Industry Co., Ltd.): | |

### (Solvents Added to Finish)

| | |
|---|---|
| Cyclohexanone: | 200.0 parts |
| Methyl ethyl ketone: | 200.0 parts |

(2) Formula of Nonmagnetic Layer Composition

| | |
|---|---|
| Nonmagnetic inorganic powder α-Iron oxide: | 100.0 parts |
| Average particle size: 10 nm | |
| Average acicular ratio: 1.9 | |
| BET specific surface area: 75 m²/g | |
| Carbon black (average particle size: 20 nm): | 25.0 parts |
| SO₃Na group-containing polyurethane resin: | 18.0 parts |

(weight average molecular weight: 70,000, SO₃Na groups: 0.2 meq/g)

| | | |
|---|---|---|
| Stearic acid: | 1.0 | part |
| Cyclohexanone: | 300.0 | parts |
| Methyl ethyl ketone: | 300.0 | parts |

(3) Formula of Backcoat Layer Composition

| | | |
|---|---|---|
| Nonmagnetic inorganic powder α-Iron oxide: | 80.0 | parts |
| Average panicle size: 0.15 μm | | |
| Average acicular ratio: 7 | | |
| BET specific surface area: 52 m²/g | | |
| Carbon black (average particle size: 20 nm): | 20.0 | parts |
| Vinyl chloride copolymer: | 13.0 | parts |
| Sulfonic acid group-containing polyurethane resin: | 6.0 | parts |
| Phenylphosphonic acid: | 3.0 | parts |
| Cyclohexanone: | 155.0 | parts |
| Methyl ethyl ketone: | 155.0 | parts |
| Stearic acid: | 3.0 | parts |
| Butyl stearate: | 3.0 | parts |
| Polyisocyanate: | 5.0 | parts |
| Cyclohexanone: | 200.0 | parts |

(4) Fabrication of Magnetic Tape

The above magnetic liquid was dispersed for 24 hours in a batch-type vertical sand mill. Zirconia heads 0.5 mmΦ in diameter were employed as dispersion beads. The abrasive liquid was dispersed for 24 hours in a batch-type ultrasonic device (20 kHz, 300 W). These dispersions were mixed with the other components (silica sol, other components, and solvents added to finish) and then processed for 30 minutes in a batch-type ultrasonic device (20 kHz, 300 W). Subsequently, the mixture was filtered with a filter having an average pore diameter of 0.5 μm to fabricate a magnetic layer composition.

For the nonmagnetic layer composition, the various components were dispersed for 24 hours in a batch-type vertical sand mill. Zirconia heads 0.1 mmΦ in diameter were employed as dispersion beads. The dispersion obtained was filtered with a filter having average pore diameter of 0.5 μm to fabricate a nonmagnetic layer composition.

For the backcoat layer composition, the various components excluding the lubricants (stearic acid and butyl stearate), the polyisocyanate, and 200.0 parts of the cyclohexanone were kneaded and diluted in an open kneader and then subjected to 12 passes of dispersion processing, each pass comprising a retention time of 2 minutes, at a rotor top peripheral speed of 10 m/s and a bead fill rate of 80 volume % using zirconia beads 1 mmΦ in diameter in a horizontal-type bead mill disperser. Subsequently, the remaining components were added to the dispersion and the mixture was stirred in a dissolver. The dispersion obtained was then filtered with a filter having an average pore diameter of 1 μm to fabricate a backcoat layer composition.

Subsequently, the nonmagnetic layer composition was coated to a thickness following drying of 100 nm on a polyethylene naphthalate film (support) 5 μm in thickness, after which the magnetic layer composition was coated thereover to a thickness upon drying of 70 nm. While the magnetic layer composition was still wet, a perpendicular orientation treatment was conducted by applying a magnetic field with a field strength of 0.6 T in a direction perpendicular to the coated surface. The coating was then dried. Subsequently, the backcoat layer composition was coated and dried on the opposite surface of the support to a dry thickness of 0.4 μm.

Subsequently, a surface smoothing treatment (calender treatment) was conducted at a calender roll surface temperature of 100° C., a linear pressure of 300 kg/cm (294 kN/m), and a speed of 100 m/minute with a calender comprised solely of metal rolls. Then, a heat treatment was conducted for 36 hours in an environment with an atmospheric temperature of 70° C. Following the heat treatment, the product was slit to ½ inch (0.0127 meter) width to obtain a magnetic tape.

[Methods of Evaluating Magnetic Tapes]

### 1. Evaluation of Magnetic Characteristics (Signal-to-Noise Ratio (SNR))

A magnetic signal was recorded in the longitudinal direction of the tape under the following conditions on each of the magnetic tapes that had been fabricated, and reproduced with a magnetoresistive (MR) head. The reproduced signal was frequency analyzed with a spectrum analyzer made by Shibasoku. The ratio of the 300 kfci output to the noise integrated over a range of 0 to 600 kfci was adopted as the SNR.

### (Recording and Reproduction Conditions)

| | | | |
|---|---|---|---|
| Recording: | Recording track width: | 5 | μm |
| | Recording gap: | 0.17 | μm |
| | Head saturation flux density Bs: | 1.8 | T |
| Reproduction: | Reproduction track width: | 0.4 | μm |
| | Shield spacing (sh-sh distance): | 0.08 | μm |
| | Recording wavelength: | 300 | kfci |

2. Drop in Reproduction Output with Repeated Reproduction (Reproduction Output Decay)

A recording head (metal-in-gap (MIG), gap: 0.15 μm, 1.8 T) and a giant magnetoresistive (GMR) reproduction head (reproduction track width: 1 μm) were mounted on a loop tester. A signal was recorded at a linear density of 200 kfci on each of the tapes that had been fabricated. The recorded signal was repeatedly reproduced and the decay in reproduction output for the time from recording to reproduction was measured. In cases where the decay in reproduction output fell below the detection limit (−0.5%/decade), “>−0.5%” was recorded in Table 2.

The results are given in Table 2.

TABLE 2

| | | | | | | | Surface |
|---|---|---|---|---|---|---|---|
| | | | | | | | layer portion |
| | | | | Content of | Localized | | content |
| | | | | ellipsoidal | presence | Surface | of rare |
| | | Nitrate | | particles | of rare earth | layer | earth atoms |
| | Type of | of rare | | based on | atoms in the | portion | atom % |
| | hexagonal | earth | Shape of | particle | surface layer | content/bulk | (per 100 atom |
| | ferrite | atom M | powder | number | portion | content | % of Fe) |
| Ex. 1 | BaFe | Y(NO₃)₃•6H₂O | Ellipsoidal | 65 | Yes | 2.9 | 3.5 |
| Ex. 2 | BaFe | Y(NO₃)₃•6H₂O | Ellipsoidal | 66 | Yes | 3.9 | 15.7 |
| Ex. 3 | BaFe | Y(NO₃)₃•6H₂O | Ellipsoidal | 70 | Yes | 4.0 | 21.3 |
| Ex. 4 | BaFe | Y(NO₃)₃•6H₂O | Ellipsoidal | 69 | Yes | 5.3 | 32.0 |
| Ex. 5 | BaFe | Y(NO₃)₃•6H₂O | Ellipsoidal | 55 | Yes | 2.1 | 1.7 |
| Ex. 6 | BaFe | Y(NO₃)₃•6H₂O | Ellipsoidal | 53 | Yes | 2.2 | 1.1 |
| Comp. Ex. 1 | BaFe | Y(NO₃)₃•6H₂O | Non-ellipsoidal | 40 | Yes | 2.3 | 0.7 |
| Comp. Ex. 2 | BaFe | Y(NO₃)₃•6H₂O | Ellipsoidal | 70 | Yes | 4.6 | 39.0 |
| Comp. Ex. 3 | BaFe | | Non-ellipsoidal | 3 | No | (No rare | — |
| | | | | | | earth atom is | |
| | | | | | | contained.) | |
| Comp. Ex. 4 | BaFe | Y(NO₃)₃•6H₂O | Ellipsoidal | 0 | Yes | 10.0 | 47.8 |
| | | (Surface treatment | | | | | |
| | | was conducted in | | | | | |
| | | Comp. Ex. 3.) | | | | | |
| Comp. Ex. 5 | BaFe | Y(NO₃)₃•6H₂O | Ellipsoidal | 63 | No | 1.0 | 4.1 |
| Ex. 7 | BaFe | Y(NO₃)₃•6H₂O | Ellipsoidal | 65 | Yes | 4.3 | 17.0 |
| Ex .8 | BaFe | Y(NO₃)₃•6H₂O | Ellipsoidal | 66 | Yes | 4.1 | 16.5 |
| Ex. 9 | BaFe | Y(NO₃)₃•6H₂O | Ellipsoidal | 66 | Yes | 3.2 | 12.9 |
| Ex. 10 | BaFe | Y(NO₃)₃•6H₂O | Ellipsoidal | 66 | Yes | 3.2 | 12.7 |
| Comp. Ex. 6 | BaFe | Y(NO₃)₃•6H₂O | Ellipsoidal | 69 | Yes | 3.1 | 12.5 |
| Comp. Ex. 7 | BaFe | Y(NO₃)₃•6H₂O | Ellipsoidal | 55 | Yes | 4.5 | 18 |
| Comp. Ex. 8 | BaFe | None | Ellipsoidal | 60 | No | (No rare | — |
| | | | | | | earth atom is | |
| | | | | | | contained.) | |
| Ex. 11 | BaFe | La(NO₃)₃•6H₂O | Ellipsoidal | 60 | Yes | 3.5 | 14.9 |
| Ex. 12 | BaFe | Nd(NO₃)₃•6H₂O | Ellipsoidal | 68 | Yes | 5.1 | 19.5 |
| Ex. 13 | BaFe | Sm(NO₃)₃•6H₂O | Ellipsoidal | 60 | Yes | 4.2 | 14.8 |
| Ex. 14 | BaFe | Yb(NO₃)₃•5H₂O | Ellipsoidal | 62 | Yes | 3.3 | 13.0 |
| Ex. 15 | SrFe | Y(NO₃)₃•6H₂O | Ellipsoidal | 66 | Yes | 3.7 | 15.0 |

| | Rare earth | | | | | |
|---|---|---|---|---|---|---|
| | atom | | | | | |
| | content | | | | | |
| | (bulk | | | | | |
| | content) | | Anisotropy | Anisotropy | | Decay in |
| | atom % | Activation | constant | constant | | reproduction |
| | (per 100 atom | volume | Ku | Ku | SNR | output |
| | % of Fe) | nm³ | ×10⁴ J/m³ | ×10⁶ erg/cc | dB | %/decade |
| Ex. 1 | 1.2 | 1040 | 1.6 | 2.0 | +0.6 | >−0.5 |
| Ex. 2 | 4.0 | 1050 | 1.6 | 2.0 | +0.8 | >−0.5 |
| Ex. 3 | 5.3 | 1060 | 1.7 | 2.1 | +0.7 | −0.6 |
| Ex. 4 | 6.0 | 1060 | 1.8 | 2.2 | +0.6 | −0.9 |
| Ex. 5 | 0.8 | 1040 | 1.6 | 2.0 | +0.7 | −0.7 |
| Ex. 6 | 0.5 | 1040 | 1.6 | 2.0 | +0.6 | −0.9 |
| Comp. Ex. 1 | 0.3 | 1050 | 1.2 | 1.5 | −0.1 | −2.1 |
| Comp. Ex. 2 | 8.5 | 1080 | 1.1 | 1.4 | −1.0 | −2.4 |
| Comp. Ex. 3 | — | 1000 | 1.0 | 1.2 | ±0.0 | −2.5 |
| Comp. Ex. 4 | 4.8 | 1000 | 1.0 | 1.3 | −0.3 | −2.4 |
| Comp. Ex. 5 | 4.0 | 1050 | 1.2 | 1.5 | ±0.0 | −2.0 |
| Ex. 7 | 4.0 | 1190 | 1.8 | 2.2 | +0.5 | >−0.5 |
| Ex .8 | 4.0 | 1130 | 1.7 | 2.1 | +0.7 | >−0.5 |
| Ex. 9 | 4.0 | 890 | 1.6 | 2.0 | +0.6 | >−0.5 |
| Ex. 10 | 4.0 | 840 | 1.6 | 2.0 | +0.5 | >−0.5 |
| Comp. Ex. 6 | 4.0 | 750 | 1.2 | 1.5 | +0.4 | −2.0 |
| Comp. Ex. 7 | 4.0 | 1300 | 2.0 | 2.5 | −1.5 | >−0.5 |
| Comp. Ex. 8 | — | 1200 | 1.0 | 1.3 | −0.2 | −2.5 |
| Ex. 11 | 4.2 | 1090 | 1.7 | 2.1 | +1.0 | >−0.5 |
| Ex. 12 | 3.8 | 1030 | 1.7 | 2.1 | +1.0 | >−0.5 |
| Ex. 13 | 3.5 | 1050 | 1.6 | 2.0 | +1.1 | >−0.5 |
| Ex. 14 | 4.0 | 1040 | 1.6 | 2.0 | +1.2 | >−0.5 |
| Ex. 15 | 4.1 | 1010 | 1.8 | 2.2 | +1.5 | >−0.5 |

Based on the results in Table 2, the magnetic tapes of Examples can be confirmed to exhibit a high SNR and little drop in reproduction output with repeated reproduction (low reproduction output decay).

An aspect of the present invention is useful in the technical field of magnetic recording media for high-density recording.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. Hexagonal ferrite powder,
which has:
an activation volume of greater than or equal to 800 nm³ but less than 1,200 nm³;
a rare earth atom content falling within a range of 0.5 to 8.0 atom % per 100 atom % of iron atoms; and
a localized presence of rare earth atoms in the surface layer portion; and
which is in the farm of ellipsoidal powder.

2. The hexagonal ferrite powder according to claim 1,
wherein the rare earth atom is one or more types of rare earth atom selected from the group consisting of a yttrium atom, lanthanum atom, samarium atom, ytterbium atom, and neodymium atom.

3. The hexagonal ferrite powder according to claim 1,
wherein the rare earth atom comprises at least a yttrium atom.

4. The hexagonal ferrite powder according to claim 1,
wherein the rare earth atom comprises at least a lanthanum atom.

5. The hexagonal ferrite powder according to claim 1,
wherein the rare earth atom comprises at least a samarium atom.

6. The hexagonal ferrite powder according to claim 1,
wherein the rare earth atom comprises at least a ytterbium atom.

7. The hexagonal ferrite powder according to claim 1,
wherein the rare earth atom comprises at least a neodymium atom.

8. The hexagonal ferrite powder according to claim 1,
which is barium ferrite powder, strontium ferrite powder, or a mixed crystal powder of barium ferrite and strontium ferrite.

9. The hexagonal ferrite powder according to claim 1,
wherein the rare earth atom content falls within a range of 0.5 to 6.0 atom %.

10. The hexagonal ferrite powder according to claim 1,
wherein the rare earth atom content falls within a range of 1.0 to 4.5 atom %,

11. The hexagonal ferrite powder according to claim 1,
wherein the activation volume falls within a range of 850 nm³ to 1,150 nm³.

12. The hexagonal ferrite powder according to claim 1,
which has an anisotropy constant Ku of greater than or equal to 1.5×10⁴ J/m³.

13. A magnetic recording medium,
which comprises a magnetic layer comprising ferromagnetic powder and hinder on a nonmagnetic support, wherein
the ferromagnetic powder is the hexagonal ferrite powder according, to claim 1.

14. A method of manufacturing hexagonal ferrite powder,
wherein the hexagonal ferrite powder is the hexagonal ferrite powder according to claim 1, and
the method comprises:
mixing an iron salt, divalent metal salt, and rare earth salt in a water-based solution to prepare a hexagonal ferrite precursor; and
continuously feeding a water-based solution containing the hexagonal ferrite precursor to a reaction flow path in which a fluid flowing through an interior of the reaction flow path is heated and pressurized, thereby converting the hexagonal ferrite precursor to hexagonal ferrite in the reaction flow path.

15. The method of manufacturing hexagonal ferrite powder according to claim 14,
wherein the reaction flow path is a reaction flow path heating a fluid flowing through the interior to greater than or equal to 300° C. and pressurizing the fluid to greater than or equal to 20 MPa.

16. The method of manufacturing hexagonal ferrite powder according to claim 14,
wherein the mixing is conducted in the presence of a base.
